(19) United States
(12) Patent Application Publication
(10) Pub. No.: US 2013/0207816 A1
(43) Pub. Date: Aug. 15, 2013

(54) APPARATUS, SYSTEM, AND METHOD TO FACILITATE EFFICIENT PUBLIC TRANSPORTATION

(71) Applicant: Wynn Louis Olson, (US)

(72) Inventor: Wynn Louis Olson, West Valley City, UT (US)

(73) Assignee: Wynn Louis Olson, West Valley City, UT (US)

(21) Appl. No.: 13/767,434

(22) Filed: Feb. 14, 2013

Related U.S. Application Data
(60) Provisional application No. 61/598,730, filed on Feb. 14, 2012.

(51) Int. Cl. G08G 1/0962; G01C 21/34

(52) U.S. Cl. CPC G08G 1/0962; G01C 21/34
USPC 340/901; 701/119; 701/533

(57) ABSTRACT

An apparatus, system, and method are disclosed for facilitating efficient public transportation. The method includes the steps of receiving a request for transportation, identifying a public transportation vehicle that services the public transportation stop, communicating the request for transportation to an operator of the public transportation vehicle, identifying a location of the public transportation vehicle, and communicating the location of the public transportation vehicle to the user. The request for transportation is received at a user interface positioned at a public transportation stop along a public transportation route.

### CROSS-REFERENCES TO RELATED APPLICATIONS

This application claims the benefit of, U.S. Provisional Patent Application No. 161/59,730 entitled “APPARATUS, SYSTEM, AND METHOD TO FACILITATE EFFICIENT PUBLIC TRANSPORTATION” and filed on Feb. 14, 2012 for Wynn Louis Olson, which is incorporated herein by reference.

### FIELD

This invention relates to public transportation and more particularly relates to efficient communication of public transportation requests from a user of a public transportation system to an operator of a public transportation vehicle.

### BACKGROUND

Public transportation is as shared passenger service which is available for use by the general public. Examples include buses, trolleys, trams, trains, metros, subways, and ferries. Most public transportation methods operate on a scheduled timetable wherein the transportation vehicles travel a predetermined path according to a schedule.

Operators of the public transportation vehicles attempt to maintain the transportation schedule by traveling the predetermined path and stopping at each stop along the path to pick up and drop off users of the transportation system. Stopping at each stop along the path ensures that passengers will be able to access the transportation vehicle. However, many stops do not have passengers needing transportation. Stopping at a stop that does not have a passenger waiting to utilize the public transportation system delays the public transportation vehicle. Over the course of a public transportation route, the delays associated with stopping at stops that do not have passengers can be significant.

Additionally, stopping at a stop that does not have a passenger waiting to board the public transportation vehicle introduces unnecessary wear on the public transportation vehicle. Similarly, as will be evident to one of skill in the art, starting and stopping a large vehicle, such as the vehicles typically used as a public transportation vehicle, waists a lot of fuel.

Stops utilized for accessing and departing public transportation vehicles can attract criminals. The stops are areas where individuals who wish to utilize the public transportation system must access or depart the vehicles. Criminals, knowing that individuals will be at these stops, may use the stops as an area to attack their victims. Therefore, to make the stops safer, public transportation authorities may wish to illuminate the stops. However, illuminating the stops throughout the night can be costly.

### SUMMARY

From the foregoing discussion, it should be apparent that a need exists for an apparatus, system, and method that facilitates efficient public transportation. Beneficially, such an apparatus, system, and method would also provide enhanced security while eliminated unnecessary expenditures on lighting for public transportation stops.

The present invention has been developed in response to the present state of the art, and in particular, in response to the problems and needs in the art that have not yet been fully solved by currently available public transportation systems. Accordingly, the present invention has been developed to provide an apparatus, system, and method for facilitating efficient public transportation that overcomes many or all of the above-discussed shortcomings in the art.

The apparatus to facilitate efficient public transportation is provided with a plurality of modules configured to functionally execute the necessary steps of receiving a request for transportation, identifying a public transportation vehicle that services the stop and communicating the request for transportation to an operator of the public transportation vehicle that services the public transportation stop. These modules in the described embodiments include a user interface, a locator module and a communication module.

The user interface, in one embodiment, is positioned at a public transportation stop along a public transportation route. The user interface is configured to receive a request for transportation from a user. The locator module identifies a public transportation vehicle that services the public transportation stop along the public transportation route in response to the request for transportation from the user. The communication module communicates the request for transportation to the operator of the public transportation vehicle that services the public transportation stop along the public transportation route. The communication of the request informs the operator of the public transportation vehicle that services the public transportation stop along the public transportation route that the user has requested transportation.

In certain embodiments, the communication module also communicates the location of the public transportation stop along the public transportation route to the operator of the public transportation vehicle. In another embodiment, the apparatus also includes a location identification module and a location communication module. In such an embodiment, the location identification module identifies a location of the public transportation vehicle and the location communication module communicates the location of the public transportation vehicle to the user.

The apparatus, in another embodiment, also includes a distance calculation module that calculates a distance between a physical location of the public transportation stop and the location of the public transportation vehicle. In one embodiment, the location communication module communicates the distance between the physical location of the public transportation stop and the location of the public transportation vehicle to the user.

In yet another embodiment, the apparatus includes a speed sensing module and a time of arrival calculation module. The speed sensing module is configured to determine an average speed of the public transportation vehicle. The time of arrival calculation module calculate an estimated time of arrival using the distance calculated by the distance calculation module and the speed determined by the speed sensing module.

In certain embodiments, the apparatus includes a traffic lookup module that accesses a traffic map. In such an embodiment, the traffic map may identify a traffic pattern for the route of the public transportation vehicle. For example, the traffic map may identify at least one of an average traffic speed along the public transportation route, accidents along the public transportation route, and construction along the public transportation route. In one embodiment, the time of arrival calculation module uses the traffic pattern in calculating the estimated time of arrival.

In yet another embodiment, the apparatus includes a route selection module that receives a route selection from the user. In certain embodiments, the route selection identifies a desired route of the user and the communication module communicates the request for transportation to an appropriate operator of the public transportation vehicle based on the route selection from the user.

In one embodiment, the apparatus includes a detour advisory module programmed to identify a detour along the public transportation route. In such an embodiment, the detour advisory module advises the user of the detour along the public transportation route. In certain embodiments, the detour advisory module may communicate at least one of an alternate route and an alternate public transportation stop in response to the detour advisory module identifying the detour along the public transportation route.

The apparatus, in yet another embodiment, also includes a mapping module and the user interface is further configured to receive a user's desired destination. In such an embodiment, the mapping module may be configured to map a route to the user's desired destination.

In another embodiment, the apparatus includes a sensing module and a lighting module. In such an embodiment, the sensing module is configured to sense an approach and a departure of a public transportation vehicle. The lighting module turns on a light to illuminate an area surrounding the user interface in response to the sensing module sensing the approach of the public transportation vehicle and the lighting module turns off the light in response to the sensing module sensing the departure of the public transportation vehicle.

A method for facilitating efficient public transportation is also disclosed which includes the steps of receiving a request for transportation, identifying a public transportation vehicle that services the public transportation stop, communicating the request for transportation to an operator of the public transportation vehicle, identifying a location of the public transportation vehicle, and communicating the location of the public transportation vehicle to the user. In certain embodiments the request for transportation is received at a user interface positioned at a public transportation stop along a public transportation route.

In one embodiment, the method also includes calculating a distance between a physical location of the public transportation stop and the location of the public transportation vehicle. In such an embodiment, the method may also include communicating the distance between the physical location of the public transportation stop and the location of the public transportation vehicle to the user.

In another embodiment, the method includes calculating an estimated time of arrival of the public transportation vehicle and communicating the estimated time of arrival of the public transportation vehicle to the user. In such an embodiment, calculating the estimated time of arrival may be accomplished by identifying a traffic pattern for the public transportation route. The traffic pattern, in certain embodiments, includes at least one of an average traffic speed along the public transportation route, accidents along the public transportation route, and construction along the public transportation route.

In yet another embodiment, the method includes identifying a detour along the public transportation route and advising the user of the detour along the public transportation route. In another embodiment, the method includes communicating either an alternate route to the user or an alternate public transportation stop in response to identifying the detour along the public transportation route.

A computing system for facilitating efficient public transportation is also disclosed. In one embodiment, the computing system includes a memory and a processor coupled with the memory. The processor is configured to perform a method that includes receiving a request for transportation from a user at a user interface, identifying a public transportation vehicle that services a public transportation stop along the public transportation route, and communicating the request for transportation to an operator of the public transportation vehicle.

In one embodiment, the method also includes identifying a location of the public transportation vehicle and communicating the location of the public transportation vehicle to the user. In another embodiment, the method includes communicating an estimated time of arrival of the public transportation vehicle to the user. In such an embodiment, the method may also include identifying a traffic pattern comprising at least one of an average traffic speed along the public transportation route, accidents along the public transportation route, and construction along the public transportation route and using the traffic pattern in calculating the estimated time of arrival.

### BRIEF DESCRIPTION OF THE DRAWINGS

In order that the advantages of the subject matter will be readily understood, a description of the subject matter rendered by reference to specific embodiments that are illustrated in the appended drawings. Understanding that these drawings depict only typical embodiments of the subject matter and are not therefore to be considered to be limiting of its scope, the subject matter will be described and explained with additional specificity and detail through the use of the accompanying drawings, in which:

FIG. 1 is a schematic block diagram illustrating one embodiment of an apparatus to facilitate efficient public transportation in accordance with the present subject matter;

FIG. 2 is a schematic block diagram illustrating one embodiment of an apparatus to facilitate efficient public transportation with two way communication between a user at a public transportation stop and a public transportation vehicle in accordance with the present subject matter;

FIG. 3 is a schematic block diagram illustrating one embodiment of an apparatus to facilitate efficient public transportation with two way communication between a user at a public transportation stop and a public transportation vehicle in accordance with the present subject matter;

FIG. 4 is a schematic block diagram illustrating one embodiment of an apparatus to facilitate efficient public transportation with improved safety measures for the public transportation stop in accordance with the present subject matter; and

FIG. 5 is a schematic flow chart diagram illustrating one embodiment of a method for facilitating efficient public transportation in accordance with the present subject matter.

### DETAILED DESCRIPTION

As will be appreciated by one skilled in the art, aspects of the present subject matter may be embodied as a system, method or computer program product. Accordingly, aspects of the present subject matter may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present subject matter may take the form of a computer program product embodied in one or more computer readable medium(s) having computer readable program code embodied thereon.

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of executable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices. Where a module or portions of a module are implemented in software, the software portions are stored on one or more computer readable mediums.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing.

More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present subject matter may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to a computer through any type of network, including a local area network (LAN) or a wide area network (WAN), or the connection may be made to an external computer (for example, through the Internet using an Internet Service Provider).

Reference throughout this specification to “one embodiment,” “an embodiment,” or similar language means that a particular feature, structure, or characteristic described in connection with the embodiment is included in at least one embodiment of the present subject matter. Thus, appearances of the phrases “in one embodiment,” “in an embodiment,” and similar language throughout this specification may, but do not necessarily, all refer to the same embodiment.

Furthermore, the described features, structures, or characteristics of the subject matter may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the subject matter. One skilled in the relevant art will recognize, however, that the subject matter may be practiced without one or more of the specific details, or with other methods, components, materials, and so forth. In other instances, well-known structures, materials, or operations are not shown or described in detail to avoid obscuring aspects of the subject matter.

Aspects of the present subject matter are described below with reference to schematic flowchart diagrams and/or schematic block diagrams of methods, apparatuses, systems, and computer program products according to embodiments of the subject matter. It will be understood that each block of the schematic flowchart diagrams and/or schematic block diagrams, and combinations of blocks in the schematic flowchart diagrams and/or schematic block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the schematic flowchart diagrams and/or schematic block diagrams block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The schematic flowchart diagrams and/or schematic block diagrams in the Figures illustrate the architecture, functionality, and operation of possible implementations of apparatuses, systems, methods and computer program products according to various embodiments of the present subject matter. In this regard, each block in the schematic flowchart diagrams and/or schematic block diagrams may represent a module, segment, or portion of code, which comprises one or more executable instructions for implementing the specified logical function(s).

It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and computer instructions.

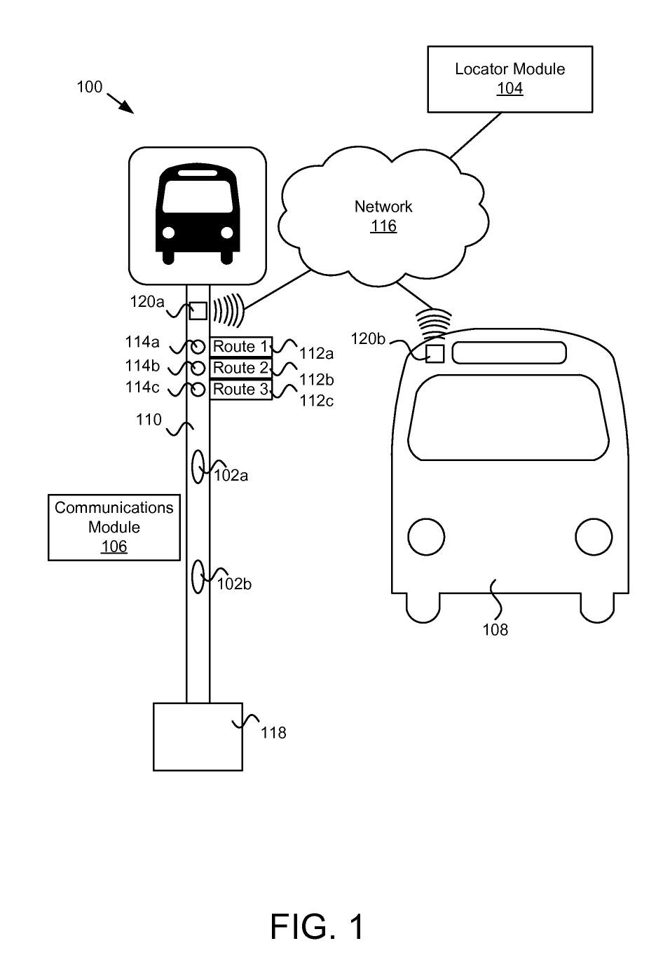

FIG. 1 depicts one embodiment of an apparatus 100 to facilitate efficient public transportation. In certain embodiments, the apparatus 100 includes a user interface 102, a locator module 104, and a communication module 106.

In one embodiment, the user interface 102 is simply a button configured to receive a request for transportation from a user. In the embodiment illustrated in FIG. 1, the user interface 102 includes two buttons 102a and 102b positionable at a public transportation stop 110 along a public transportation route. In certain embodiments, the buttons 102a and 102b may be substantially similar to conventional buttons found at a crosswalk or as are used for other traffic control situations known in the art. The use of two buttons 102a and 102b, in one embodiment, accommodates shorter individuals or individuals who are confined to a wheelchair. In such an embodiment, the top button 102a is positioned at a height that is comfortable for a user of average height to use. The bottom button 102b is positioned at a height that is comfortable for shorter users or users confined to a wheelchair. In certain embodiments, the apparatus 100 may include a single user interface 102 instead of the two buttons 102a and 102b depicted in FIG. 1.

One of skill in the art will recognize that a public transportation system typically includes many different public transportation routes with many different public transportation vehicles 108 servicing various public transportation stops 110 along the public transportation routes. Similarly, one of skill in the art will recognize that a single stop 110 may service many public transportation routes. Accordingly, in one embodiment, the apparatus 100 may include a plurality of route indicators 112, with each route indicator 112 including a route signaling member 114 configured to identify a route selected by the user. For example, in one embodiment, the user may depress one of the buttons 102a or 102b to select a desired route. Depressing one of the buttons 102a or 102b once, in certain embodiments, indicates that the user desires to travel along route 1. Depressing one of the buttons 102a or 102b twice indicates that the user desires to travel along route 2. Depressing one of the buttons 102a or 102b a third time indicates that the user desires to travel along route 3. In certain embodiments, depressing one of the buttons 102a or 102b a fourth time cycles back to indicate that the user wishes to travel along route 1. Of course a particular public transportation stop 110 may include a greater or fewer number of route indicators 112 depending on the number of routes serviced by that public transportation stop 110.

In certain embodiments, upon depressing one of the buttons 102a or 102b one or more times, the route signaling member 114 corresponding to the appropriate route indicates the route selected. If the user desires a different route, the user can depress one of the buttons 102a or 102b one or more times to change the selected route to the route desired by the user. In certain embodiments, the route signaling members 114 are lights positioned adjacent the route indicators 112 and the appropriate route signaling member 114 is illuminated according to the number of times the buttons 102a or 102b are depressed. In other embodiments, the route signaling member 114 may be a speaker or other audible device that audibly announces the selected route. In yet another embodiment, the apparatus 100 may include both an audible device as well as lights as the route signaling member 114.

While the embodiment illustrated in FIG. 1 depicts the user interface 102 as one or more buttons configured to cycle through a number of possible routes, one of skill in the art will recognize that in certain embodiments, the user interface 102 may include a plurality of input buttons with each input button corresponding to a specific route. In another embodiment, the user interface 102 may be a computer (not shown) configured to receive input via a keyboard, touch pad, touch screen, or any other method for receiving input from a user as is known in the art. The computer, in such an embodiment, may communicate with the route indicators 112 to indicate the selected route to the user. In yet another embodiment, the computer may include one or more screens or other display devices (not shown) configured to communicate the selected route to the user so that the user can verify that the desired route was selected.

In certain embodiments, the apparatus 100 includes a locator module 104 configured to identify a public transportation vehicle 108 that services the public transportation stop 110 from which a request for transportation originates. In one embodiment, the locator module 104 is a database which includes a listing for each public transportation vehicle 108 in the public transportation system. The database, in certain embodiments, identifies each public transportation vehicle 108 and also identifies which routes each public transportation vehicle services. In one embodiment, each public transportation stop 110 includes a locator module 104. In another embodiment, each public transportation vehicle 108 includes a locator module 104. In other embodiments, the locator module 104 may reside on a computer hard drive or other storage media located at the control center for the public transportation system. Of course, one of skill in the art will recognize that the locator module 104 may reside on any computer hard drive or other storage media as long as the hard drive or storage media is accessible via a wired or wireless network such as network 116.

In certain embodiments the apparatus 100 includes a communication module 106 configured to communicate the request for transportation from the user to an operator of the public transportation vehicle 108 that services the public transportation stop 110 along the public transportation route. The communication module 106 is coupled to and communicates with a first transceiver 120a positioned on and/or coupled to the public transportation stop 110. A second transceiver 120b is positioned on or in the public transportation vehicle 108b. In certain embodiments, the first and second transceivers 120a and 120b communicate with one another via wireless communication technology as is known in the art.

When the user interface 102 receives a request for transportation from a user, the user interface 102 communicates with the first transceiver 120a to cause the first transceiver 120a to send the request to the locator module 104 via network 116 to identify the appropriate public transportation vehicle 108 from the locator module 104. In embodiments where the locator module 104 is located on a hard drive or other recording media at the public transportation stop 110, the hard drive or other recording media at the public transportation stop 110 is accessed to identify the appropriate public transportation vehicle 108. Once the appropriate public transportation vehicle 108 is identified, the request is transmitted to that public transportation vehicle 108 via network 116 where it is received by the second transceiver 120b. Communication of the request between the first transceiver 120a and the second transceiver 120b may be accomplished through wireless communication as is known in the art.

The communication of the request informs the operator of the public transportation vehicle 108 that services the public transportation stop 110 along the public transportation route that the user has requested transportation. In certain embodiments, the communication of the request also informs the operator of the public transportation vehicle 108 that services the public transportation stop 110 along the public transportation route of the location of the public transportation stop 110. In one embodiment, the request is communicated to the operator of the public transportation vehicle 108 via a speaker (not shown) positioned within the public transportation vehicle 108. In another embodiment, the public transportation vehicle 108 includes a display for visually communicating the request to the operator of the public transportation vehicle 108. In either embodiment, the operator of the public transportation vehicle 108 that services the public transportation stop 110 along the public transportation route is made aware of an awaiting customer at a particular public transportation stop 110 and the operator can plan to stop the public transportation vehicle 108 accordingly.

While the embodiments depicted herein illustrate the public transportation vehicle 108 as a bus, one of skill in the art will recognize that in certain embodiments, the apparatus 100 is equally applicable to other public transportation vehicles. For example, in certain embodiments, the apparatus 100 may be used with trains, light rail transportation vehicles, taxi cabs or the like.

In certain embodiments, the circuitry for the apparatus 100, such as the circuitry for the communication module 106, may be positioned within a housing 118. In certain embodiments the housing 118 is positioned at or below the surface upon which the public transportation vehicle 108 travels. The housing 118, in one embodiment, is made of a weatherproof material to keep the circuitry dry. In certain embodiments, the circuitry is configured to sever any ground connections if the public transportation stop 110 is struck by a vehicle. The housing 118 is tamper resistant to avoid damage to the apparatus 100 from vandals.

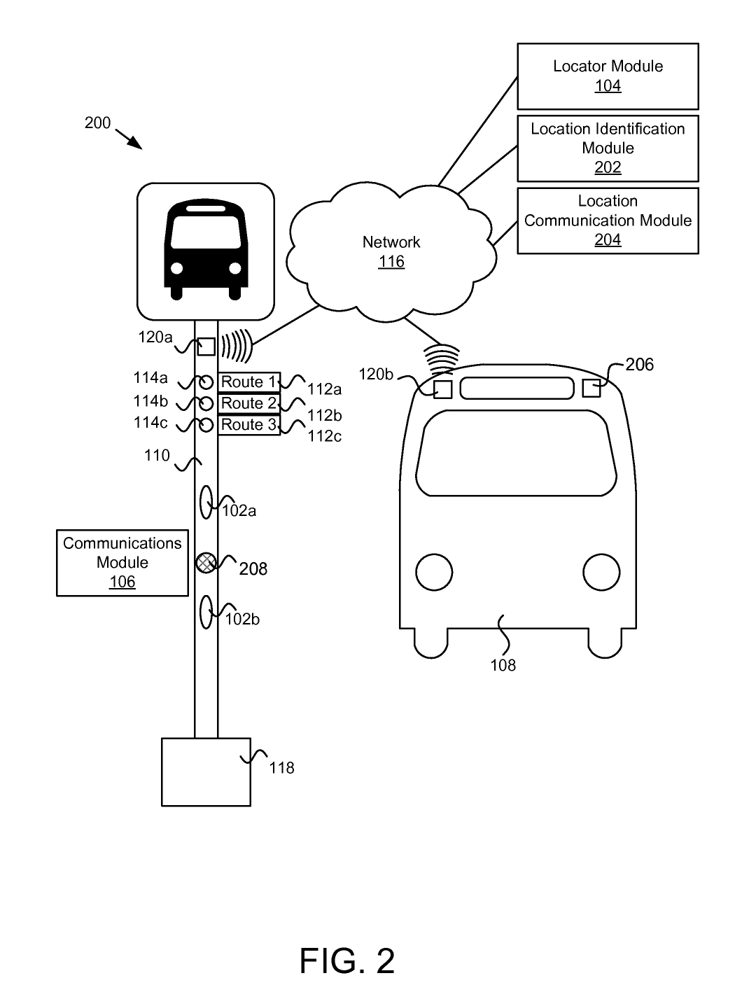

FIG. 2 depicts one embodiment of an apparatus 200 to facilitate efficient public transportation. In certain embodiments, the apparatus 200 includes a user interface 102, a locator module 104, a communication module 106, a location identification module 202, and a location communication module 204. The user interface 102, the locator module 104 and the communication module 106, in one embodiment, are substantially similar to the user interface 102, the locator module 104 and the communication module 106 discussed above with reference to apparatus 100.

In one embodiment, the location identification module 202 is configured to identify a location of the public transportation vehicle 108. For example, in certain embodiments, each public transportation vehicle 108 includes a location identification unit 206. The location identification unit 206, in one embodiment, is a global positioning system that communicates with satellites to determine the location of the public transportation vehicle 108. In other embodiments, the location identification unit 206 may be a local positioning system that use a set of beacons (cellular based stations, Wi-Fi access points, etc.) to determine the location of the public transportation vehicle 108.

To identify the location of the public transportation vehicle 108, the location identification module 202 queries the location identification unit 206 on the appropriate public transportation vehicle 108. In certain embodiments, the location identification module 202 wirelessly communicates with the second transceiver 120b on the public transportation vehicle 108 to query the location identification unit 206.

In response to the query, the location identification unit 206 identifies the location of the public transportation vehicle 108 and transmits the location to a location communication module 204 via the second transceiver 120b. The location communication module 204 can then communicate the location of the public transportation vehicle 108 to the user at the public transportation stop 110. In certain embodiments, the location communication module 204 transmits the location of the public transportation vehicle 108 to the first transceiver 120a and the location of the transportation vehicle 108 is audibly communicated to the user via a speaker 208 coupled to the public transportation stop 110. In other embodiments, as discussed below, the apparatus 200 includes a visual display such as a computer screen that visually communicates the location of the public transportation vehicle 108 to the user.

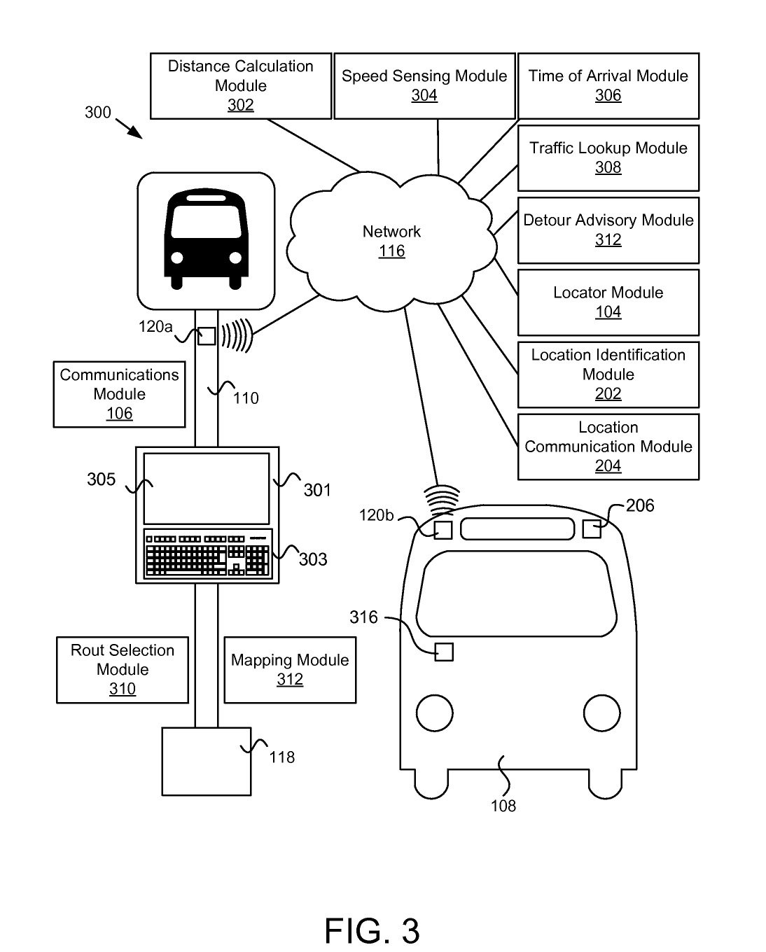

FIG. 3 depicts one embodiment of an apparatus 300 to facilitate efficient public transportation. In certain embodiments, the apparatus 300 includes a user interface 301, a locator module 104, and a communication module 106. The locator module 104 and the communication module 106, in one embodiment, are substantially similar to the locator module 104 and the communication module 106 discussed above with reference to apparatus 100. In one embodiment, the apparatus 300 also includes a location identification module 202 and a location communication module 204 which are substantially similar to the location identification module 202 and the location communication module 204 discussed above with reference to apparatus 200.

In certain embodiments, the user interface 301 may be a computer configured to receive input from a user via a keyboard 303. In the embodiment illustrated in FIG. 3, the keyboard 303 is a conventional keyboard as is known in the art. In other embodiments, the keyboard 303 may include keys specific to the functions described herein. In yet another embodiment, the user interface 301 may include a touch pad, touch screen, or any other method for receiving input from a user as is known in the art. In one embodiment, the user interface 301 also includes a display 305 for communicating information to the user as further discussed below.

In one embodiment, a particular public transportation stop 110 may service multiple routes to multiple destinations. In such an embodiment, the public transportation stop 110 may receive multiple public transportation vehicles 108, with each public transportation vehicle 108 arriving from and/or heading to a different destination. Therefore, the apparatus 300 may include a route selection module 310 configured to receive a route selection from the user. The route selection identifies the desired route of the user and the communication module 106 communicates the request for transportation to an operator of the appropriate public transportation vehicle 108 based on the route selected by the user.

In one embodiment, the apparatus 300 may also include a mapping module 312 to assist a user in determining an appropriate route to reach their desired destination. In such an embodiment, the display 305 may be configured to display one or more destination options. The user interface 301 is configured to receive the user's desired destination and the mapping module 312 maps a route to the user's desired destination. In one embodiment, the map of the route to the user's desired destination is displayed on the display 305 of the user interface 301. The map of the route to the user's desired destination, in certain embodiments, includes all of the intermediate public transportation stops 110 along the way.

Where the public transportation stop 110 services more than one route, the display 305 of the user interface 301 may display the route selected by the user. Alternatively, the selected route may be displayed by one of the plurality of route indicators 112 as discussed above. In embodiments that include a display 205, the display 305 may also display other information such as the location of the next available public transportation vehicle 108, the distance between the public transportation stop 110 and the next available public transportation vehicle 108, the anticipated time of arrival for the next available public transportation vehicle 108, traffic patterns along the desired route, alternative route options, detours along the route, and a map of travel options within the transportation system.

The apparatus 300, in certain embodiments, also includes one or more of a distance calculation module 302, a speed sensing module 304, a time of arrival module 306, a traffic lookup module 308, a detour advisory module 312, and a mapping module 314.

In certain embodiments, the distance calculation module 302 is configured to calculate a distance between a physical location of the public transportation stop 110 and the location of the public transportation vehicle 108. In such an embodiment, the distance calculation module 302 may include a stop location database (not shown) that lists the physical location of each public transportation stop 110 in the public transportation system. The distance calculation module 302 queries the location identification module 202 to determine the location of the public transportation vehicle 108. Using the physical location of the public transportation stop 110 from the stop location database and the location of the public transportation vehicle 108 provided by the location identification module 202, the distance calculation module 302 calculates the distance between the public transportation stop 110 and the public transportation vehicle 108.

In one embodiment, the location communication module 204 communicates the distance between the physical location of the public transportation stop 110 and the location of the public transportation 108 vehicle to the user. In certain embodiments, the location communication module 204 communicates the distance between the physical location of the public transportation stop 110 and the location of the public transportation 108 to the user by sending the distance information from the second transceiver 120b to the first transceiver 120a. Once the first transceiver 120a receives the distance information, the user interface 301 may display the distance information on the display 305 of the user interface 301. In other embodiments the apparatus 300 may include a speaker substantially similar to speaker 208 discussed above in relation to apparatus 200. In such an embodiment, once the first transceiver 120a receives the distance information, the distance information may be audibly announced to the user on the speaker 208. In yet another embodiment, the distance information may be visually communicated to the user on the display 305 and also audibly communicated to the user on the speaker 208.

In certain embodiments, the apparatus 300 includes a speed sensing module 304 configured to determine an average speed of the public transportation vehicle 108. In one embodiment, the speed sensing module 304 communicates with the location identification unit 206 to determine a location of the public transportation vehicle 108 at a first moment in time. The speed sensing module 304 then communicates with the location identification unit 206 to determine a location of the public transportation vehicle 108 at a second moment in time. The speed sensing module 304 can then use the distance traveled between the first moment in time and the second moment in time along with the elapsed time between the first moment in time and the second moment in time to calculate an average speed of the public transportation vehicle 108.

In another embodiment, the speed sensing module 304 may communicate with a speed sensing unit 316 in the public transportation vehicle 108 to determine an average speed of the public transportation vehicle 108. For example, in one embodiment, the speed sensing unit 316 may be coupled to a speedometer or other speed indicated device within the public transportation vehicle 108. The speed sensing unit 316 may record an average speed for the public transportation vehicle 108 and report the average speed to the speed sensing module 304 in response to a request from the speed sensing module 304.

A time of arrival calculation module 306, in certain embodiments, calculates an estimated time of arrival of the public transportation vehicle 108 at the public transportation stop 110. In one embodiment, the time of arrival calculation module 306 uses the distance of the public transportation vehicle 108 from the public transportation stop 110 calculated by the distance calculation module 302 and the average speed of the public transportation vehicle 108 determined by the speed sensing module 304 to calculate the estimated time of arrival of the public transportation vehicle 108 at the public transportation stop 110. In one embodiment, the time of arrival calculation module 306 is configured to communicate the estimated time of arrival to the user visually via the display 305 of the user interface 301 and/or audibly via the speaker 208.

One of skill in the art will recognize that the time of arrival of the public transportation vehicle 108 at the public transportation stop 110 may vary depending on traffic patterns along the route taken by the public transportation vehicle 108. Accordingly, in certain embodiments, the apparatus 300 may include a traffic lookup module 308 configured to access a traffic map (not shown) to determine traffic patterns along the route. For example, in certain embodiments, the traffic patterns may be variables such as an average traffic speed of other vehicles along the public transportation route, whether or not there are any accidents reported along the public transportation route, whether or not there is any construction occurring along the public transportation route, etc. In certain embodiments, the estimated time of arrival calculation module 306 uses the variables in the traffic patterns along the public transportation route to refine the estimated time of arrival calculation.

In one embodiment, the apparatus 300 also includes a detour advisory module 312 configured to identify a detour along the public transportation route. In certain embodiments, the detour advisory module queries a government run or privately operated traffic operations center to identify detours along the public transportation route. In other embodiments, the public transportation system may include a traffic operations center that monitors traffic patterns along the public transportation route to identify detours or other traffic issues.

If a detour is identified, the detour advisory module 312 is configured to advise the user of the detour along the public transportation route. In certain embodiments, the detour advisory module 312 advised the user of a detour by displaying an advisory on the display 305 of the user interface 301. In another embodiment, the detour advisory module 312 audibly advises the user of the detour through a speaker such as speaker 208.

In certain embodiments, the detour advisory module 312 is also configured to communicate an alternate route to the user in response to the detour advisory module 312 identifying a detour along the public transportation route. In yet another embodiment, the detour advisory module 312 communicates an alternate public transportation stop 110 to the user in response to the detour advisory module 312 identifying a detour along the public transportation route.

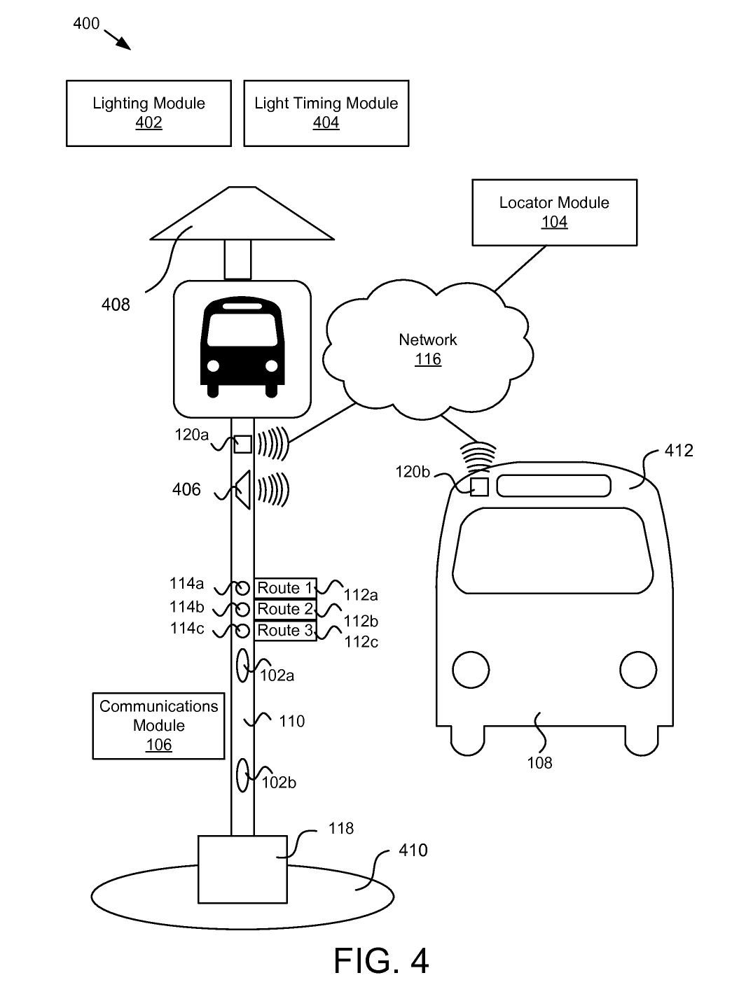

FIG. 4 depicts one embodiment of an apparatus 400 to facilitate efficient public transportation. In certain embodiments, the apparatus 400 includes a user interface 102, a locator module 104, and a communication module 106. The user interface 102, locator module 104, and communication module 106 may be substantially similar to the user interface 102, locator module 104, and communication module 106 of apparatus 100. In other embodiments, the user interface 102 may be substantially similar to the user interface 301 of apparatus 300. In yet another embodiment, the apparatus 400 may include other modules such as the location identification module 202, the location communication module 204, the distance calculation module 302, the speed sensing module 304, the time of arrival module 306, the traffic lookup module 308, the route selection module 310, the detour advisory module 312 and/or the mapping module 314 discussed above with reference to apparatus 200 and apparatus 300.

In certain embodiments, the apparatus 400 also includes one or more of a lighting module 402, a light timing module 404, and a sensing module 406. The lighting module 402, in one embodiment, is configured to turn on a light 408 to illuminate an area 410 surrounding the user interface 102 in response to the user interface 102 receiving a request for transportation from the user. By illuminating the illuminated area 410 the safety of the public transportation stop 110 is enhanced for the user.

In one embodiment, a light timing module 404 is coupled to the light 408. The light timing module 404 may be configured to turn off the light 408 after a predefined period of inactivity at the user interface 102. For example, in certain embodiments, once a user has initiated a request for transportation by depressing one of the buttons 102a or 102b of the user interface 102, the lighting module 402 turns on the light 408. After a predefined period the light timing module 404 turns off the light 408 if there has been no subsequent activity at the user interface 102. In one embodiment, the predefined period may be an average wait time between the arrival of each public transportation vehicle 108 at the public transportation stop 110. In another embodiment, the predefined period may be the longest wait time between the arrival of each public transportation vehicle 108 at the public transportation stop 110. In yet another embodiment, the light timing module 404 may communicate with the time of arrival module 306 to determine an estimated time of arrival. In such an embodiment, the light timing module 404 may use the estimated time until arrival as the predefined period. In one embodiment, the light timing module 404 may add time to the estimated time until arrival to allow for boarding and/or exiting the public transportation vehicle 108.

In another embodiment, the apparatus 400 may include a sensing module 406 configured to turn off the light 408. In certain embodiments, the sensing module 406 may turn off the light 408 in response to a lack of movement in the area surrounding the public transportation stop 110. In another embodiment, the sensing module 406 may be configured to sense the departure of the public transportation vehicle 108 from the public transportation stop 110 and to turn off the light 408 in response to sensing the departure of the public transportation vehicle 108 from the public transportation stop 110.

In one embodiment, the sensing module 406 is positioned at a height accessible by an upper portion 412 of the public transportation vehicle 108. One of skill in the art will recognize that public transportation vehicles 108 are typically taller than conventional consumer vehicles. Accordingly, in certain embodiments, the sensing module 406 may be positioned at a height that is higher than the height of a conventional consumer vehicle. In such an embodiment, the upper portion 412 of the public transportation vehicle 108 may be considered the portion of the public transportation vehicle that is taller than a conventional consumer vehicle.

In another embodiment, the sensing module 406 may be configured to receive a signal from the public transportation vehicle 108. The signal may be configured to indicate an approach of the public transportation vehicle 108 and/or a departure of the public transportation vehicle 108. In one embodiment, the second transceiver 120b may be configured to communicate the signal. In other embodiments, the public transportation vehicle 108 may include a separate transceiver or signal communicating device specifically configured to send the signal. In either embodiment, the sensing module 406 may be configured to cause the lighting module 402 to turn on the light 408 in response to the sensing module 406 sensing the approach of the public transportation vehicle 108. Similarly, the sensing module 406 may be configured to cause the lighting module to turn off the light 408 in response to the sensing module 406 sensing the departure of the public transportation vehicle 108.

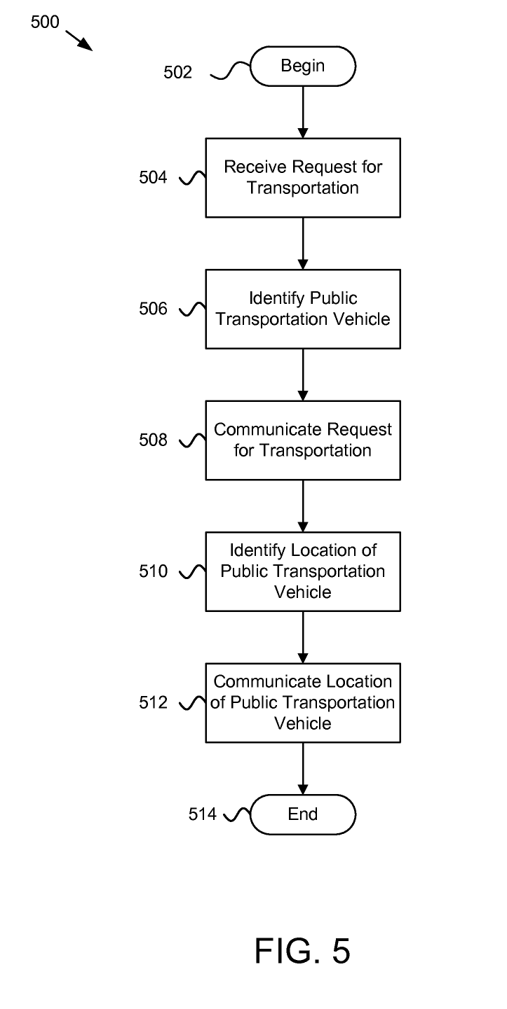

FIG. 5 depicts one embodiment of a method 500 to facilitating efficient public transportation. The method 500 will be described with reference to apparatus 200 of FIG. 2. One of skill in the art will recognize that in certain embodiments, the method 500 may be practiced with any of the apparatus described above.

The method 500 begins 502 and a request for transportation is received 504 from a user at a user interface 102. In embodiments where the user interface is one or more buttons 102a and 102b, the request is received by the user depressing one of the buttons 102a or 102b one or more times. In embodiments where the user interface is a computer terminal, such as the user interface 301 of apparatus 300, the request may be received 504 by the user inputting the request for transportation into the keyboard 303 of the user interface 301. In other embodiments, the user interface 301 may include a touch screen for receiving 504 the request for transportation. One of skill in the art will recognize other forms of a user interface may be utilized for receiving 504 the request for transportation such as a cellular device, wireless communication device, etc.

Upon receiving 504 the request for transportation, a locator module 104 identifies 506 the public transportation vehicle 108 that services the public transportation stop 110 along the public transportation route is identified 506. The request for transportation is communicated 508 to an operator of the public transportation vehicle 108 that services the public transportation stop 110 along the public transportation route. The communication 508 of the request to the operator of the public transportation vehicle 108 informs the operator of the public transportation vehicle 108 that services the public transportation stop 110 along the public transportation route that the user has requested transportation. In certain embodiments, the communication 508 of the request for transportation also informs the operator of the public transportation vehicle 108 of the location of the public transportation stop 110 from which the request for transportation originated.

In one embodiment, the location identification module 202 identifies 510 the location of the public transportation vehicle 108 and the location communication module 204 communicates 512 the location of the public transportation vehicle 108 to the user. The method then ends 514.

The present subject matter may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. An apparatus to facilitate efficient public transportation, the apparatus comprising:
a user interface positioned at a public transportation stop along a public transportation route, the user interface receiving a request for transportation from a user;
a locator module that identifies a public transportation vehicle that services the public transportation stop along the public transportation route in response to the request for transportation from the user; and
a communication module that communicates the request for transportation to an operator of the public transportation vehicle that services the public transportation stop along the public transportation route, the communication of the request informing the operator of the public transportation vehicle that services the public transportation stop along the public transportation route that the user has requested transportation.

2. The apparatus of claim 1, wherein the communication module communicates the location of the public transportation stop along the public transportation route to the operator of the public transportation vehicle.

3. The apparatus of claim 1, further comprising a location identification module and a location communication module, the location identification module identifying a location of the public transportation vehicle, wherein the location communication module communicates the location of the public transportation vehicle to the user.

4. The apparatus of claim 3, further comprising a distance calculation module that calculates a distance between a physical location of the public transportation stop and the location of the public transportation vehicle, wherein the location communication module communicates the distance between the physical location of the public transportation stop and the location of the public transportation vehicle to the user.

5. The apparatus of claim 4, further comprising a speed sensing module and a time of arrival calculation module, the speed sensing module determining an average speed of the public transportation vehicle, the time of arrival calculation module calculating an estimated time of arrival using the distance calculated by the distance calculation module and the speed determined by the speed sensing module.

6. The apparatus of claim 5, further comprising a traffic lookup module that accesses a traffic map, the traffic map identifying a traffic pattern comprising at least one of an average traffic speed along the public transportation route, accidents along the public transportation route, and construction along the public transportation route, wherein the time of arrival calculation module uses the traffic pattern in calculating the estimated time of arrival.

7. The apparatus of claim 1, further comprising a route selection module that receives a route selection from the user, the route selection identifying a desired route of the user, wherein the communication module communicates the request for transportation to an appropriate operator of the public transportation vehicle based on the route selection from the user.

8. The apparatus of claim 1, further comprising a detour advisory module configured to identify a detour along the public transportation route, the detour advisory module advising the user of the detour along the public transportation route and wherein the detour advisory module is further configured to communicate at least one of an alternate route and an alternate public transportation stop in response to the detour advisory module identifying the detour along the public transportation route.

9. The apparatus of claim 1, further comprising a mapping module and wherein the user interface is further configured to receive a user's desired destination, the mapping module configured to map a route to the user's desired destination.

10. The apparatus of claim 1, further comprising a sensing module and a lighting module, the sensing module sensing an approach and a departure of a public transportation vehicle, wherein the lighting module turns on a light to illuminate an area surrounding the user interface in response to the sensing module sensing the approach of the public transportation vehicle and wherein the lighting module turns off the light in response to the sensing module sensing the departure of the public transportation vehicle.

11. A method comprising:
receiving a request for transportation from a user at a user interface positioned at a public transportation stop along a public transportation route;
identifying a public transportation vehicle that services the public transportation stop along the public transportation route;
communicating the request for transportation to an operator of the public transportation vehicle that services the public transportation stop along the public transportation route;
identifying a location of the public transportation vehicle; and
communicating the location of the public transportation vehicle to the user.

12. The method of claim 11, further comprising calculating a distance between a physical location of the public transportation stop and the location of the public transportation vehicle and communicating the distance between the physical location of the public transportation stop and the location of the public transportation vehicle to the user.

13. The method of claim 11, further comprising calculating an estimated time of arrival of the public transportation vehicle and communicating the estimated time of arrival of the public transportation vehicle to the user.

14. The method of claim 13, wherein calculating the estimated time of arrival comprises identifying a traffic pattern comprising at least one of an average traffic speed along the public transportation route, accidents along the public transportation route, and construction along the public transportation route.

15. The method of claim 11, further comprising identifying a detour along the public transportation route and advising the user of the detour along the public transportation route.

16. The method of claim 15, further comprising communicating at least one of an alternate route and an alternate public transportation stop in response to identifying the detour along the public transportation route.

17. A computing system, comprising:
a memory; and
a processor coupled with the memory, the processor to perform a method comprising:
receiving a request for transportation from a user at a user interface;
identifying a public transportation vehicle that services a public transportation stop along a public transportation route; and
communicating the request for transportation to an operator of the public transportation vehicle that services the public transportation stop along the public transportation route.

18. The computing system of claim 17, wherein the method further comprises identifying a location of the public transportation vehicle and communicating the location of the public transportation vehicle to the user.

19. The computing system of claim 17, wherein the method further comprises communicating an estimated time of arrival of the public transportation vehicle to the user.

20. The computing system of claim 17, wherein the method further comprises identifying a traffic pattern comprising at least one of an average traffic speed along the public transportation route, accidents along the public transportation route, and construction along the public transportation route and using the traffic pattern in calculating the estimated time of arrival.
